(19) United States
(12) Patent Application Publication
(10) Pub. No.: US 2011/0298916 A1
(43) Pub. Date: Dec. 8, 2011

(54) SENSOR SYSTEM PROCESSING ARCHITECTURE

(75) Inventor: Terry Arden, Burnaby (CA)

(73) Assignee: LMI Technologies Ltd.

(21) Appl. No.: 13/089,151

(22) Filed: Apr. 18, 2011

(51) Int. Cl. H04N 7/18

(52) U.S. Cl. 348/86; 348/E07.085

(57) ABSTRACT

A system for imaging an area using a plurality of non-contact measurement optical sensors comprises a plurality of substantially identical sensors that detect the presence of a connected network of like sensors, accept the assignment of the role of a managing sensor or a support sensor and individually image a portion of said area. Each sensor may also individually derive image information from its image. The images or image information from each of the plurality of sensors are delivered to the managing sensor which combines them with its own image or image information and that acts as the exclusive client server for delivering the combined image or combined image information to the client.

### FIELD OF THE INVENTION

This invention relates to non-contact imaging sensors. In particular the invention relates to non-contact imaging systems involving a plurality of sensors used to image the same object or area.

### BACKGROUND OF THE INVENTION

Non-contact sensors are used to image or measure objects in a wide variety of applications including automated manufacturing processes, in the retail store environment and as embodied in various consumer products. A common type of non-contact sensor relies on the use of a camera to detect light reflected from an object in the field of view of the sensor. The geometrical relationship between the light source and the camera may be used to derive spatial and dimensional information about the object.

Where the object or area to be imaged or measured is larger than the effective field of view of a sensor, a situation that is more commonly seen in manufacturing, a plurality of sensors are sometimes used to collectively acquire the image. A plurality of sensors may also be used to image multiple sides of an object so as to provide a fuller three-dimensional profile of the object than is available from a single sensor. In such cases, means are required to effectively compile and normalize the data from the fields of view of each of the different sensors in order to generate a seamless and meaningful representation of the object or area.

A typical prior art multiple sensor system, as provided by a system supplier, is illustrated in FIG. 1. A plurality of sensors consisting of S₀ and S₁ are shown in FIG. 1 although in certain applications, the system may involve many more sensors. Each sensor is connected to a dedicated PC 10 to deliver image data to the PC through cables 12 and 14. The connection is sometimes through an Ethernet switch 16 as illustrated in FIG. 1. A controller 17 supplies power, safety and synchronization signals to each of the sensors through cables 18, 20. In cases where external data in addition to the image data is needed by the PC to interpret the field of view, there may be an additional data link 22 between the controller 17 and the PC 10 via Ethernet switch 16. The PC receives the image data from sensors S₀ and S₁, interprets it, transforms the data to a common reference coordinate system, performs any metrology that may be required and delivers the results in a predetermined format for presentation to a user system 24. Although this configuration has long been the norm in the art, there is a cost in terms of the number of components being supplied by the system supplier. In addition as the number of sensors in the system is increased the amount of cabling becomes more daunting.

It will be seen that one advantage of the present invention is to reduce the number of components that needs to be supplied by the system supplier. There is also a reduction in the cabling involved and a simpler physical set up.

The configuration of the prior art system of FIG. 1 usually involves a representative of the system supplier attending at the customer premises to verify the physical set up, initialize the software on the PC 10, oversee sensor calibration and configure the system software for a customer-appropriate user interface. The present invention allows a much simpler system installation and configuration as compared to the prior art. The attendance of a supplier representative at the customer premises, though sometimes desirable, is not necessary.

While the prior art approach centralizes system management in the PC, according to the invention, there is effectively no central system management thereby providing a simpler architecture and experience from the user's point of view.

These and other objects and advantages of the invention will be better understood by reference to the detailed description of the preferred embodiment that follows.

### SUMMARY OF THE INVENTION

According to the invention, each of a plurality of non-contact measurement optical sensors is equally enabled to perform identical functions so as to enable the joint imaging of an area or of an object in an area when the sensors are networked together. No separate management system is required, each sensor being enabled to provide system initialization, synchronization and management, image processing and metrological functions as well as client server functions.

Each sensor is substantially identical and is enabled to self detect its presence in a network of like sensors and to accept the assignment of, and to assume alternative respective roles for the sensors such that one of the sensors acts as a managing sensor, compiling and combining partial images or image information acquired by the other sensors in the network, providing synchronization and trigger signals to the other sensors and acting as the client server. This eliminates the need for a separate computer system to perform such functions. Each sensor is also able to alternatively accept the role of a support sensor so as not to enable those functions that are characteristic of a managing sensor. The managing sensor handles all imaging or image information compiling functions as well as client server functions.

Following network detection, role assignment, calibration and initial synchronization, each of the managing and support sensors is enabled to image a respective portion of an area to be imaged in response to synchronization trigger signals supplied by the managing sensor. The managing sensor may take its cue from direct user input, from external signals or according to an imaging schedule.

Each sensor, whether assigned as a managing sensor or as a support sensor in a particular application, is enabled to collect and filter its own raw image data to extract a 3D image of the field of view covered by the sensor, which consists of a portion of the overall area to be imaged by the plurality of sensors in the network. Each sensor is enabled to normalized and transform the raw image data from sensor coordinates to a set of network system coordinates that are derived during a calibration step.

Each sensor may have the capability to discriminate an object or part of an object lying in the field of view and to derive a profile or a partial profile for the object. In the case of a support sensor, it transmits its partial image or profile (as the case may be) to the managing sensor over the network connection. The managing sensor combines the partial images or profiles from all support sensors with its own partial profile to generate an overall combined image or object profile.

A client device, preferably having a suitable user interface, can also be connected to the sensor network through a switch that also serves to establish the network between the sensors. The managing sensor acts as a server for the client, delivering to the client content relating to the combined image or profile.

Each sensor is also capable of performing measurements on the object profile that is derived from the sensor's image data. Such partial measurements may be combined in the managing sensor for further computation of the object characteristics. Alternatively all object measurements may be carried out in the managing sensor based on the combined data received from the various sensors in the network.

According to the preferred embodiment of the invention, object discrimination based on the image data, as well as all measurements based on image data are deferred to the managing sensor which performs such functions.

In an aspect, the invention comprises a system for imaging an area using a plurality of non-contact measurement optical sensors. The system comprises a plurality of substantially identical non-contact measurement optical sensors networked with one another. Each of the sensors comprises a computer-readable medium having recorded thereon instructions that when executed cause the sensor to detect the presence of a connected network of like sensors, accept an assignment of either of alternative roles as a managing sensor or a support sensor and acquire images of respective portions of the area. Each sensor can accept the role of a managing sensor in which case it can combine image data from respective portions of the area that are respectively acquired by each sensor. When a sensor is assigned the role of a support sensor, it delivers to the managing sensor images or image data from the portion of the area that was acquired by the support sensor.

In another aspect of the invention, the assigned managing sensor acts as a sole server for a client for interfacing with said client and for generating and outputting to the client the combined images or image data.

According to a further aspect of the invention, the image data that is acquired by each sensor and that is combined by the managing sensor may comprise representations of portions of an object within the area, each sensor having discriminated a portion of the object in its acquired image.

In another aspect of the invention, the image data acquired or derived by each sensor comprises partial dimensional information relating to an object within the area and the managing sensor combines the collected partial dimensional information to provide combined dimensions for the object.

In a further aspect, the system of sensors is calibrated in relation to a common coordinate reference system.

In another aspect, the invention comprises a system for imaging an area using a plurality of non-contact measurement optical sensors. The system comprises a plurality of substantially identical non-contact measurement optical sensors networked with one another. Each of the sensors comprises a computer-readable medium having recorded thereon instructions that when executed cause the sensor to detect the presence of a connected network of like sensors, accept an assignment of either of alternative roles as a managing sensor or a support sensor and acquire images of respective portions of the area. Each sensor can accept the role of a managing sensor in which case it can combine image data from respective portions of the area that are respectively acquired by each sensor. When a sensor is assigned the role of a support sensor, it delivers to the managing sensor images or image data from the portion of the area that was acquired by the support sensor. Upon detecting the presence of a connected network of like sensors and detecting a first connection of a client to one of the sensors in the network, one of the sensors delivers to the client a user interface offering to the client an option for a user to operate the network in multi-sensor mode for imaging the area.

In a further aspect, upon detecting such a first client connection, the sensor further delivers to the client a user interface offering to the client an option for a user to assign an IP address to that sensor, and in another aspect further offering to the client an option for assign to one of the sensors the role of a managing sensor.

In another aspect, the sensor to which the client first connects and that is assigned the role of managing sensor uses a default IP address if the client does not elect to assign a different IP address to that sensor.

In yet another aspect, the managing sensor prompts the client to specify the spatial arrangement of the various sensors in the network and may prompt the client to specify operational parameters for the system.

In another aspect, the invention comprises a system for imaging an area using a plurality of non-contact measurement optical sensors. The system comprises a first and a second non-contact measurement optical sensors, each being calibrated in relation to a common coordinate reference system. The first sensor is configured to acquire images of a respective portion of the area, to combine images or image content relating to respective portions of the area that is acquired by each of the two sensors and that each sensor has normalized to the common coordinate reference system. The first sensor acts as a server for a client for interfacing with the client and for generating and outputting to the client user content relating to the combined image or image content.

In another aspect, the image content comprises representations of portions of an object within the area, which partial representations have been derived by each sensor from the images acquired by respective ones of the sensors, including by the first sensor, and the combined image content is a combined representation of the object.

According to further aspects of the invention, the managing sensor provides system initialization and system synchronization functions.

In another aspect, the managing sensor provides the metrological functions.

In a method aspect, the invention comprises a method for imaging an area. The method comprises the steps of a first sensor being calibrated with a second sensor to operate in the same effective coordinate system, the first sensor creates a first image of a first part of the area, the second sensor creating a second image of a second part of the area. The second sensor transmits the second image to the first sensor through a network connection between them and the first sensor combines the two images to create a combined image of the area. Preferably the first sensor also outputs the combined image to a networked user device.

Other method aspects of the invention are apparent from the foregoing and from the description of the preferred embodiment that follows.

The foregoing was intended as a broad summary only and of only some of the aspects of the invention. It was not intended to define the limits or requirements of the invention. Other aspects of the invention will be inferred from the detailed description of the preferred embodiment and the claims.

### BRIEF DESCRIPTION OF THE DRAWINGS

The invention will be described by reference to the detailed description of the preferred embodiment and to the drawings thereof in which:

FIG. 1 is a diagrammatic representation of a prior art multiple sensor system;

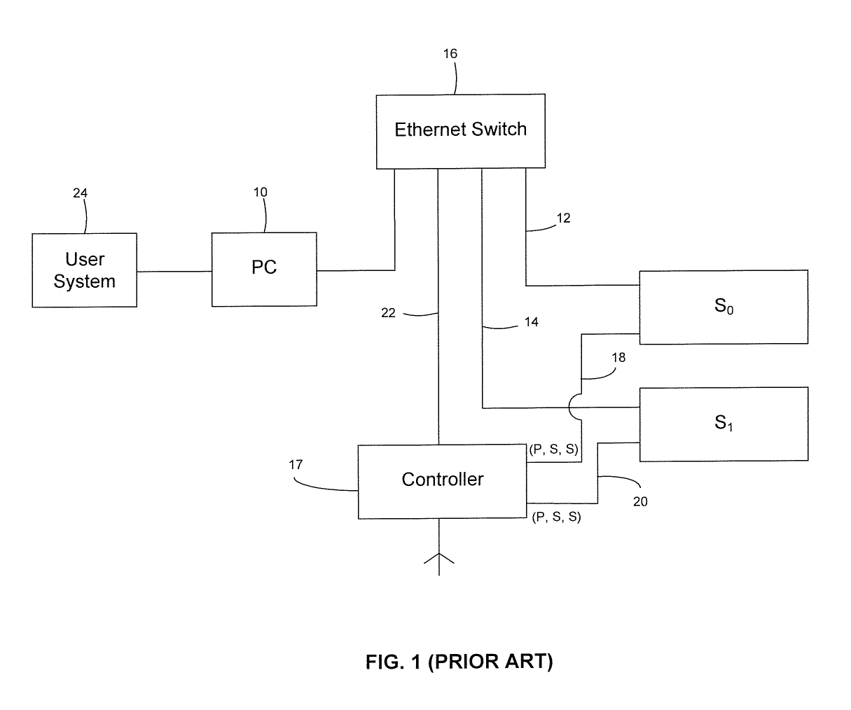

FIG. 2 shows a multiple sensor system according to the preferred embodiment of the invention;

FIG. 3 is a perspective view showing a sensor according to one embodiment of the present invention;

FIG. 4a is a flowchart showing certain functional modules of the managing and support sensors of an embodiment of the invention in which the managing sensors handles all feature detection and measurements for both sensors;

FIG. 4b is a flowchart showing certain functional modules of the managing and support sensors of an embodiment of the invention in which the support sensor performs feature detection on its own acquired image but no metrology;

FIG. 4c is a flowchart showing certain functional modules of the managing and support sensors of an embodiment of the invention in which the support sensor also provides some metrology;

FIG. 5 is a perspective view of two sensors and a common calibration target according to the invention;

FIG. 6 is a figure showing the arrangement of the sensor system according to “wide” mode embodiment of the present invention;

FIG. 7 is a figure showing the arrangement of the sensor system according to the “staggered” mode embodiment of the present invention; and,

FIG. 8 is a figure showing the arrangement of the sensor system according to the “opposite” mode embodiment of the present invention.

### DETAILED DESCRIPTION OF THE PREFERRED EMBODIMENT

The following is a description of the preferred embodiment of the invention as presently contemplated. Not all possible embodiments within the scope of the invention are described.

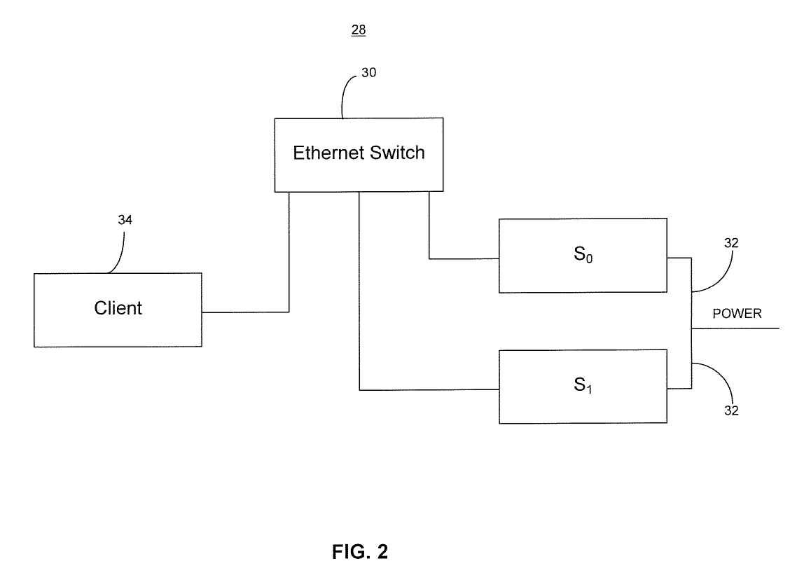

Referring now to FIG. 2, the preferred embodiment of the system 28 according to the invention comprises a managing sensor S₀ and a support sensor S₁. Although a single support sensor S₁ is used in the preferred embodiment, additional support sensors S₁ may be included in the system 28. The managing sensor S₀ and the support sensor S₁ are networked via network switch 30, preferably via Ethernet connections such that switch 30 is an Ethernet switch. Each sensor is preferably programmed with a factory assigned default IP address as well as a factory-assigned serial number.

Power is supplied to each sensor from a power source (not shown) by means of a cord set 32 connecting the sensors and that includes power cables. A client device 34, such as a computer with a user interface, may also be connected to the network via switch 30. The client device may be an operator-driven device such as a computer with a user interface, or it may be an automated system interfacing with the sensor network 28. Preferably the client is a browser that is to able to render web-style pages and to accept input from the user. While the preferred embodiment relies on a client device for initial configuration of the sensors and of the network as discussed below, reliance on the client device is not necessary to operate the system after the initial set up.

It will be appreciated that certain variations to the physical architecture of the system may be practiced without departing from the fundamental aspects of the invention. For example, a cable management system such as cable splitters may be included to organize and consolidate the cabling between the system components.

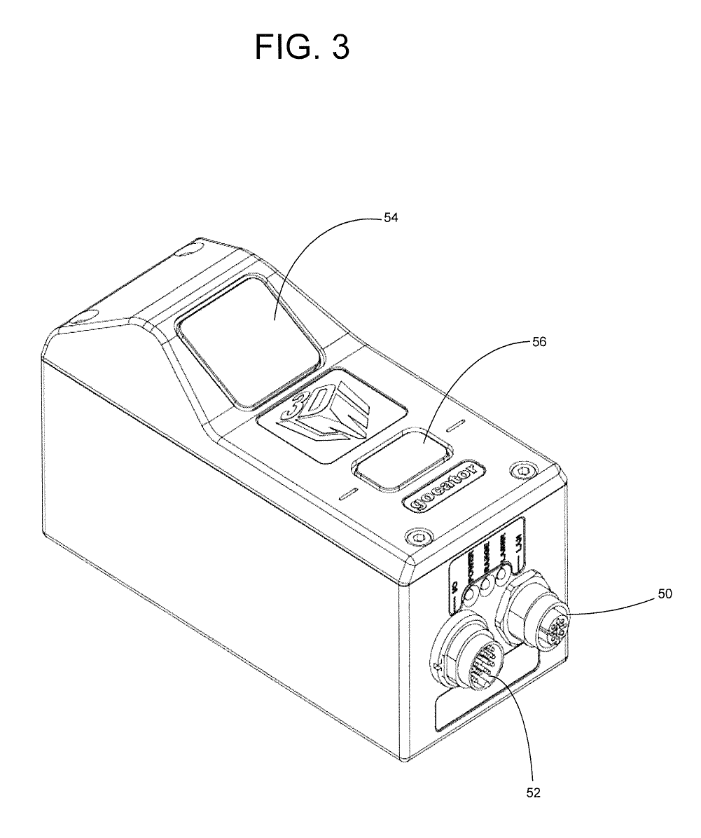

Each sensor S₀ and S₁ according to the preferred embodiment is physically identical and is identically programmed save for the factory-assigned IP addresses and serial numbers. Referring to FIG. 3, each sensor comprises a network connector 50 (in the preferred embodiment, an Ethernet connector) and a power cable connector 52. The sensor of the preferred embodiment is a triangulation-based non-contact measurement optical sensor. It should be noted that although the preferred embodiment uses the projection of a laser line, spot or time of flight sensors may equally be used in the context of the invention. A laser diode assembly is housed behind laser window 56 for projecting a laser line along the field of view. A two-dimensional array CMOS camera is housed behind camera window 54. A processing unit and a clock (not shown) are mounted within the housing of the sensor.

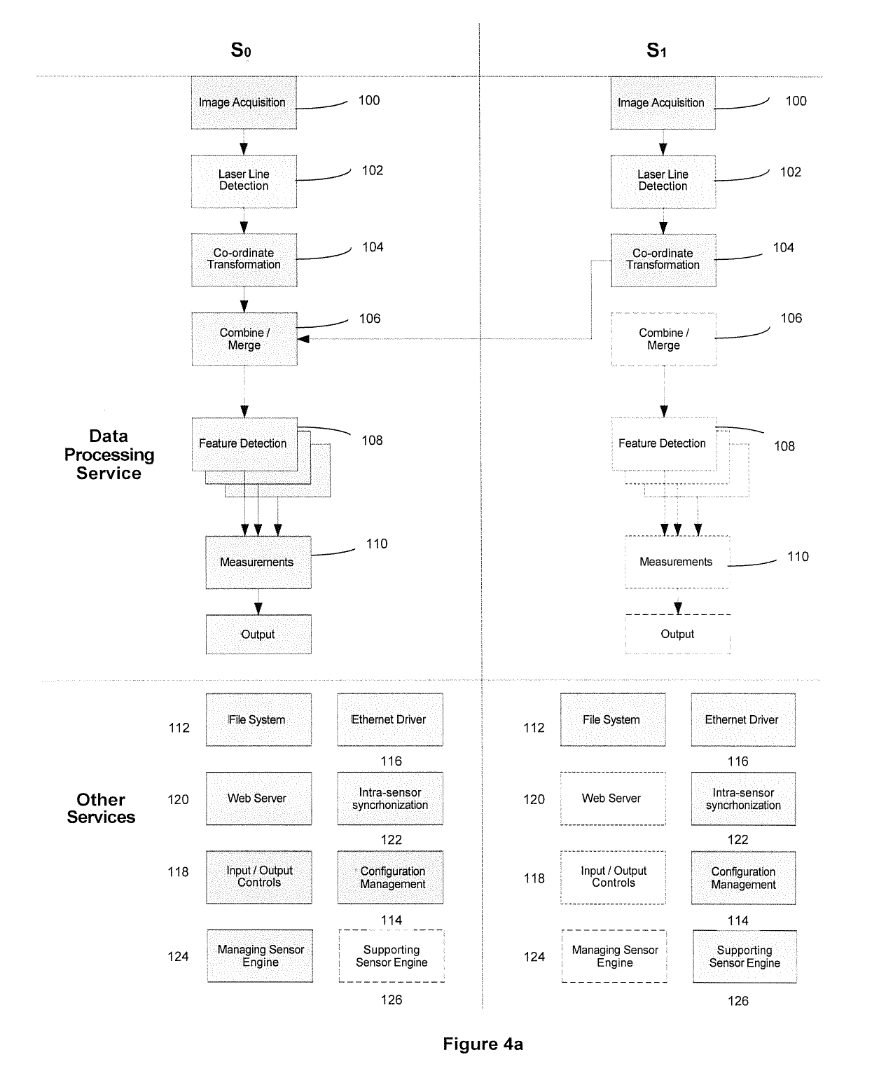

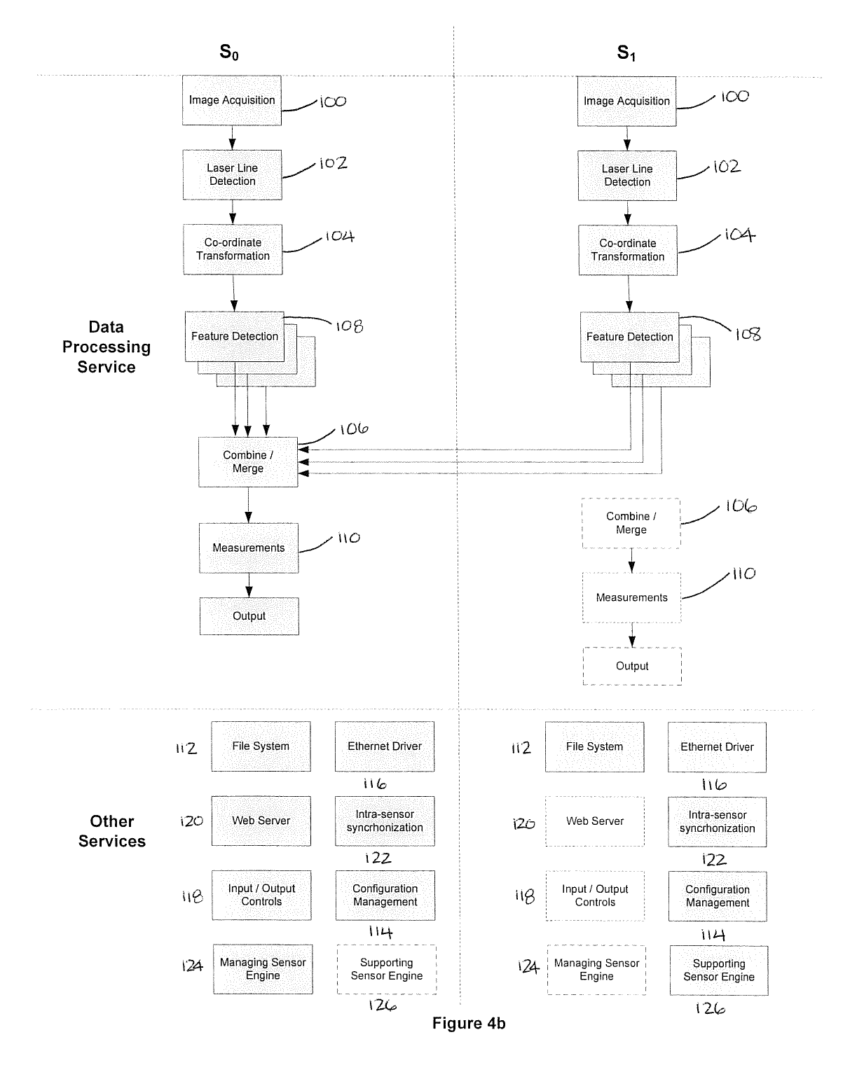

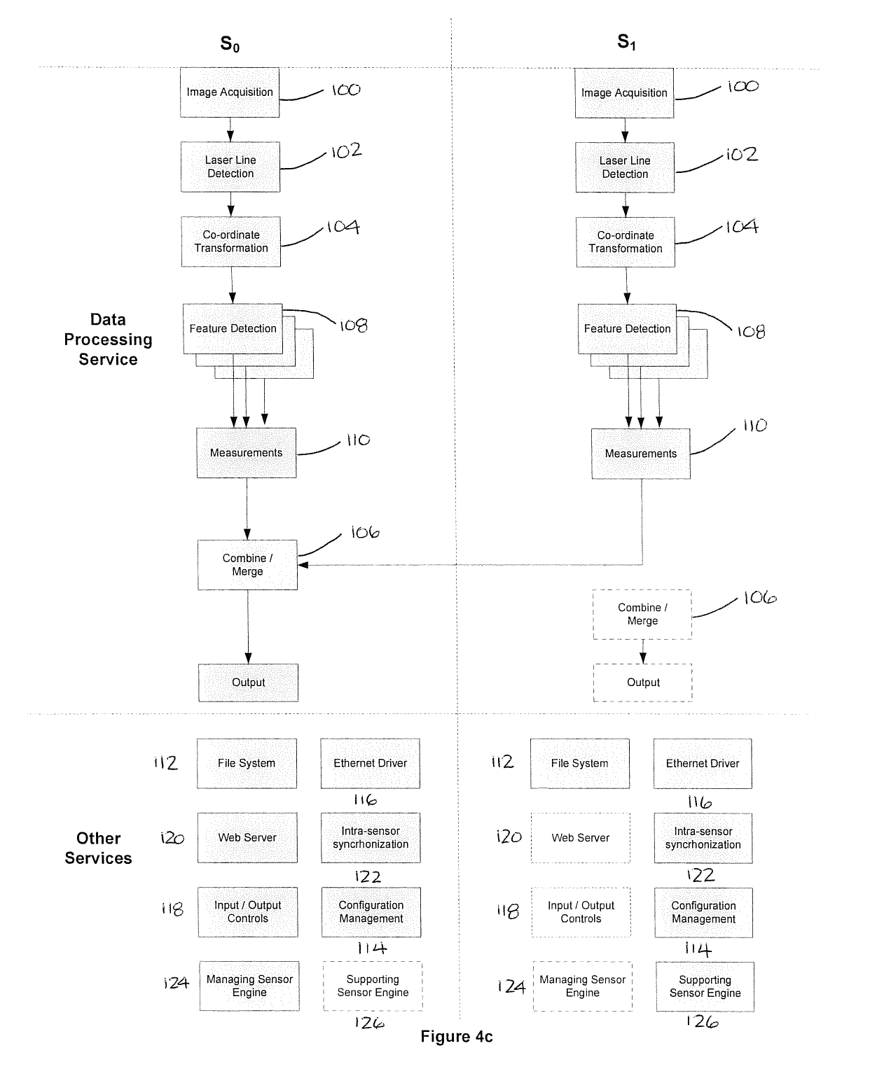

According to the preferred embodiment, the processing unit has computer-readable memory that has stored thereon software modules to provide the functions described herein, including the following functions (the reference numerals for which are used in FIGS. 4a, 4b and 4c):

TABLE 1

| | |
|---|---|
| 1. | Image Acquisition 100 |
| 2. | Laser Line Detection 102 |
| 3. | Coordinate Transformation 104 |
| 4. | Combine/Merge 106 |
| 5. | Feature Detection 108 |
| 6. | Measurements 110 |
| 7. | File System 112 |
| 8. | Configuration Management 114 |
| 9. | Ethernet Drivers 116 |
| 10. | Input/Output Controls 118 |
| 11. | Web Server 120 |
| 12. | Inter-sensor Synchronization 122 |
| 13. | Managing Sensor Engine 124 |
| 14. | Support Sensor Engine 126 |

The function of some of the modules or applications is self evident from their designation. In addition, the File System module 112 is used for storing calibration records and user configurations.

The Configuration Management module 114 controls network awareness and network configuration and the selection of user-defined set up and operational parameters.

The Managing Sensor Engine 124 contains and executes the protocols to be used when a given sensor has been designated as a managing sensor, while the Support Sensor Engine 126 contains and executes the protocols to be used when the sensor has been designated as a support sensor.

The initialization and operation of the system 28 will now be described.

### Configuration of IP Addresses

The user first configures each of the sensors' IP addresses. This is undertaken by connecting the sensor to a client device having a user interface. Upon establishing the connection, the Configuration Management module 114 of the sensor detects the connection, broadcasts its default IP address and factory serial number and eventually determines that it is networked with a client device. The Web Server 120 thereupon serves the server application to the client computer 34 including a graphical user interface with an option for the user to arrange for the assignment of a new IP address to the sensor to override the sensors default IP address. In the event that the user chooses not to arrange for the assignment of new IP addresses during initial configuration of the sensors, the sensors will operate using their factory-assigned individual default lP addresses.

### Network Awareness

The sensors are then connected to the network switch 30 and are physically arranged according to a desired imaging configuration, such configurations being discussed below. Upon a sensor's Ethernet Drivers 116 detecting a network connection, the Configuration Management modules of the sensors broadcast their IP addresses and serial numbers and await reception of similar broadcasts from other members of the network. Once received, the network memberships are recorded in each sensor.

### Command to Operate in Multi-Sensor Mode

When a client 34 addresses any sensor (by its IP address) over the network for the first time, the Web Server 120 serves up to the client 34 a graphical user interface offering the option of operating the networked sensors in multi-sensor mode for imaging a common object or area. Upon the client issuing the command to operate in mufti-sensor mode, the Web Server 120 informs the client 34 that the sensor through which the connection was established is presumptively assigned as the managing sensor S₀. The Configuration Management module 114 causes, an offer to be presented to the client 34 to re-assign the role of managing sensor S₀ to another sensor. The client accepts to designate the addressed sensor as the managing sensor or re-assigns that role to another sensor. Once one of the sensors has been determined to be the managing sensor S₀, that sensor's Managing Sensor Engine 124 assumes control of the overall operational protocols of the sensor and sends a message to the other sensors on the network declaring its status as the managing sensor and disabling similar prompts from other sensors. The Support Sensor Engine 126 of each of the other sensors thereupon records their roles in the network as support sensors S₁ and the Support Sensor Engines 126 assume control of the overall operational protocols of the support sensors. It will be appreciated that when the system is in normal operation, a client device may address the IP address of the managing sensor S₀ to establish a single point connection with the sensor network and to secure from sensor S₀ combined image capture and metrology information collected from all sensors.

### Synchronization and Calibration

The Inter-sensor Synchronization application 122 of the managing sensor S₀ then initiates a synchronization protocol whereby a synchronization command is sent to all members of the network to synchronize their respective clocks. This synchronization routine is performed at regular intervals throughout the period that the sensors are networked together.

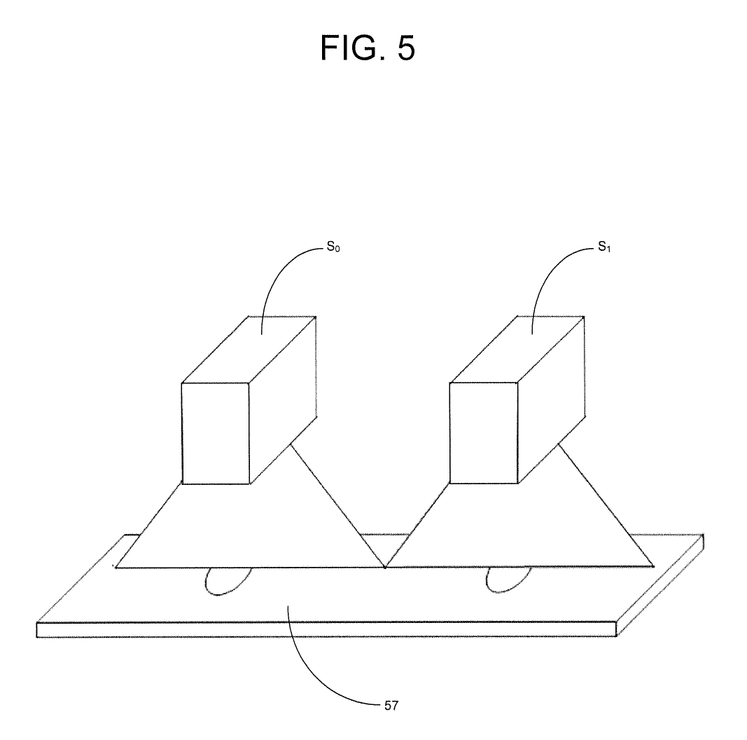

Following synchronization of the clocks, the Configuration Management module of the managing sensor S₀ causes the Web Server 120 of the managing sensor S₀ to provide a graphical user interface (GUI) to client device 34. The GUI includes a button entitled “Calibrate” that is selectable by the user. The sensors may then be calibrated to a common coordinate reference system by placing a suitable calibration target 57 to lie in the fields of view of the various networked sensors simultaneously. FIG. 5 illustrates the use of a calibration target in a so-called “wide mode” arrangement of sensors. Upon the user selecting the “Calibrate” button, the Managing Sensor Engine 124 of the managing sensor sends to all of the sensors on the network a signal to launch the calibration application along with a trigger signal to synchronize image capture. Each sensor then images the calibration target 57 and records the target's image coordinates according to the sensors coordinate system. Those target image coordinates are then used by the sensor to establish the system coordinates for the network. As all sensors image the same calibration target at the same time, the calibration target effectively provides a reference coordinate system for all sensors. The support sensor S₁ may then send the derived system coordinates to the managing sensor S₀ and store those coordinates locally in sensor S₁ as well.

Preferably, the calibration target includes asymmetrical features such that when placed in the field of view by a user during the calibration process, each sensor will be able to recognize its relative location in relation to other sensors in the network by recognizing the calibration target features within its particular field of view and referencing the relative location of such features on the target from a look up table. The knowledge of the relative positions of the sensors in relation to one another facilitates the task of the managing sensor in combining partial images or partial object profile data from the various sensors in the correct spatial relationship. This feature of the invention avoids the need for a user to is arrange the sensors in particular relative locations during set up and enhances the fungible nature of the sensors according to the invention.

Alternatively a symmetrical calibration target may be used and the user installing the sensor network may be prompted to ensure that the managing sensor is located in a particular relative location in relation to the support sensor(s) in order to provide a default basis for concatenating multiple partial images acquired by the various sensors in the network.

After calibration, the Configuration Management module 114 and the Web Server 120 of the managing sensor S₀ causes the sensor to present a GUI to the client device 34 for enabling the selection by the user of various additional (or already discussed) operational options. The options may relate to the configuration of the sensors and of the network, to the physical installation of the sensors, to the metrology enabled by the sensors or to other aspects of the system. According to the preferred embodiment, the following types of options may be made available to the user through the client:

TABLE 2

| | |
|---|---|
| 1. | IP//Network configuration (static IP/DHCP) |
| 2. | Trigger mode (e.g. time, encoder, external input) |
| 3. | Trigger timing (period, spacing, delay) |
| 4. | Overlap/Interference enable/disable. |
| 5. | Metrology tools for various measurements such as distance, |
| | width, height, angle, intersect, position, profile comparison |
| 6. | Layout (wide, top/bottom, staggered) |
| 7. | Profiling settings (exposure, active window) |
| 8. | Output selections (Ethernet as in the preferred embodiment or |
| | digital output, analog or serial in other cases) |
| 9. | Configuration files |
| 10. | Auto start |
| 11. | Anchoring/template registration |

For example, according to the layout option, the sensors may be configured for “wide”, “staggered” or “opposite” mode imaging. The user selects the layout corresponding to the physical layout of the sensors. This step is preferably done prior to calibration of the sensors in reaction to user prompts generated upon configuration of the network 28. Different exemplary arrangements or modes of operation of two sensors are discussed below.

### Data Processing Service

The imaging operation will now be described. All image capture is ultimately controlled by timing signals from the managing sensor S₀ under the control of the Managing Sensor Engine 124. Such control may comprise asynchronous image capture commands (operator driven or from an external trigger) or instructions to capture images automatically at periodic intervals. The timing signals for each image capture operation are provided by the managing sensor S₀ via a cable that forms part of cord set 32.

Referring to FIGS. 4a, 4b and 4c generally, following each image capture, the Image Acquisition and Laser Line Detection applications 100, 102 process the image to determine where the reflection appears to be located on the array, applies filtering and normalization techniques and the Coordinate Transformation application 104 transforms the partial image data to the system coordinates established during the calibration step. As shown in the embodiment of FIG. 4c, the Feature Detection module 108 of each sensor may also perform feature detection/object discrimination of the partial image captured by the sensor and metrology on the object. If the sensor in question is a support sensor, then the pre-processed partial image along with any metrology information is then communicated over the network to the managing sensor S₀. Alternatively, all metrological measurements may be deferred and performed exclusively by the Feature Detection module 104 of the managing sensor S₀, as illustrated in FIG. 4b The invention also contemplates directly delivering all raw image data, whether before or after some initial processing, to the managing sensor for further processing before combining the partial image, partial object profile or partial metrology data with those retrieved from other sensors and from the managing sensor itself. In such case, illustrated in FIG. 4a, no feature detection, object discrimination or measurements are performed by the support sensor.

Since the managing sensor S₀ and the support sensor S₁ have already been calibrated and transform their respective partial images to the system coordinates, the integration application of the Combine/Merge module 106 of the managing sensor S₀ combines the partial image data from the support sensors with its own partial image data to generate a combined image of the object or area 58.

Because the image data generated by the support sensor S₁ is combined with the image data generated by the managing sensor S₀ to create a combined image, the user accessing the managing sensor S₀ with the user device 34 is able to view and manipulate the combined image as if the data had been generated by only a single sensor. In this manner, the support sensor S₁ operates seamlessly with the managing sensor S₀ to allow the creation of a combined image or object profile.

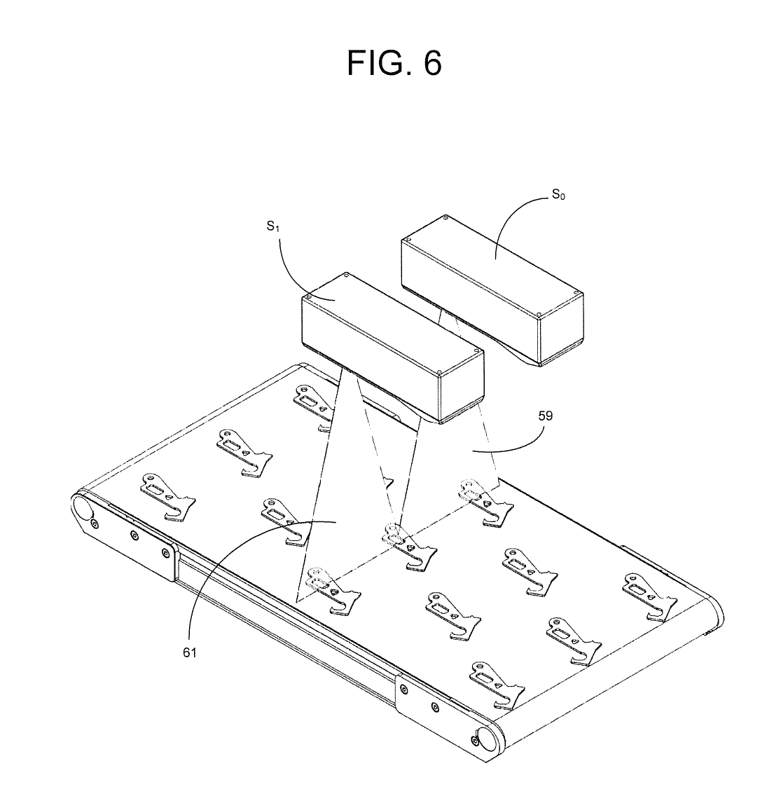

Different exemplary modes of operation of two sensors will now be described. Referring to FIG. 6, in “wide” mode, the managing sensor S₀ and the support sensor S₁ are placed side by side, separated by a known distance. The fields of view 59, 61 of their respective laser emitters behind windows 56 will either be overlapping or separated. The user is prompted to indicate whether the fields of view 59, 61 are overlapping (a selectable option in Table 2). If one of the sensors is able to detect the left edge of the object 58 and the other sensor is able to detect the right edge of the object 58, then by knowing the distance separating the sensors (which can be derived during the calibration step using a suitable scale on the calibration target), the edge-to-edge width of the object 58 can be determined. In operation, the managing sensor S₀ transmits an image timing sequence or asynchronous trigger signals to capture images. Each of the managing sensor and the support sensors captures and processes images in their respective fields of view. Where the user or client has stipulated a particular measurement, for example a width determination, the intended measurement is recorded at each sensor. Upon processing the local sensor image, each sensor may then perform the metrology available to it based on its own field of view (in this case the coordinate location of an edge) if each sensor is configured to perform such determination locally. In such case, the support sensor then sends its partial image as well as any metrology results (in this case the coordinates of an edge) to the managing sensor. The managing sensor concatenates the images (accounting for possible image overlap or gaps) for joint display at the client and combines the metrology results of both sensors to derive the estimated width of the object, which may also be delivered to the clients user interface. The ability of the individual sensors to perform metrology on their respective partial images may be appropriate in only certain cases. As mentioned above, the managing sensor may be made to perform all measurements on the combined image data.

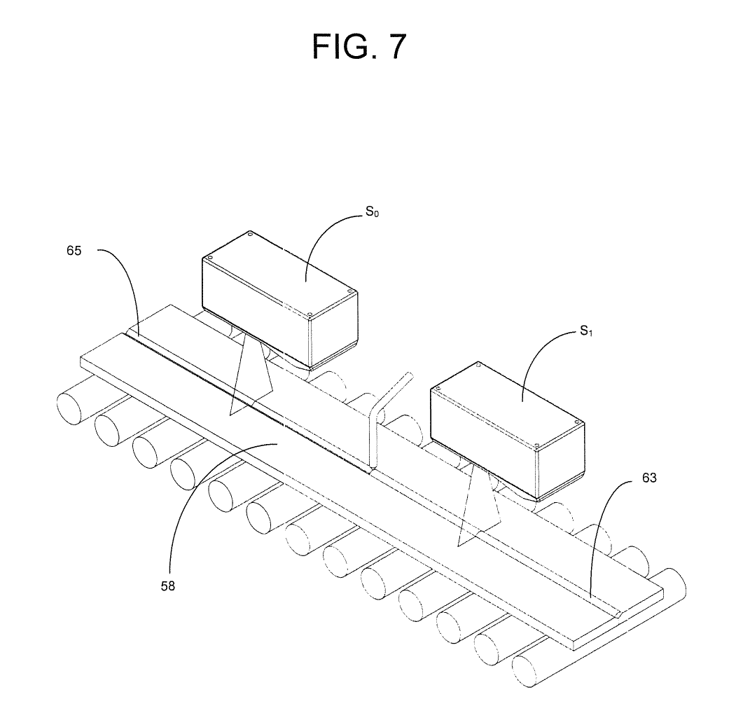

Referring to FIG. 7, the “staggered” mode is best employed in a continuous process system (e.g. a conveyer belt). For example, it may be used to measure the thickness of a bead 63 that is being applied along a seam 65 on the surface of an object 58. The support sensor S₁ is mounted inline and downstream of the managing sensor S₀. The managing sensor S₀ measures the profile of the object 58 including the seam 65 prior to the bead being applied, while the support sensor S₁ measures the profile of the object 58 after the bead is applied. When the profile from the managing sensor S₀ is combined (in a subtractive sense) with the profile from the support sensor S₁, the difference is taken to be the thickness of the bead. The shape of the completed bead may also be evaluated by the support sensor S₁ alone.

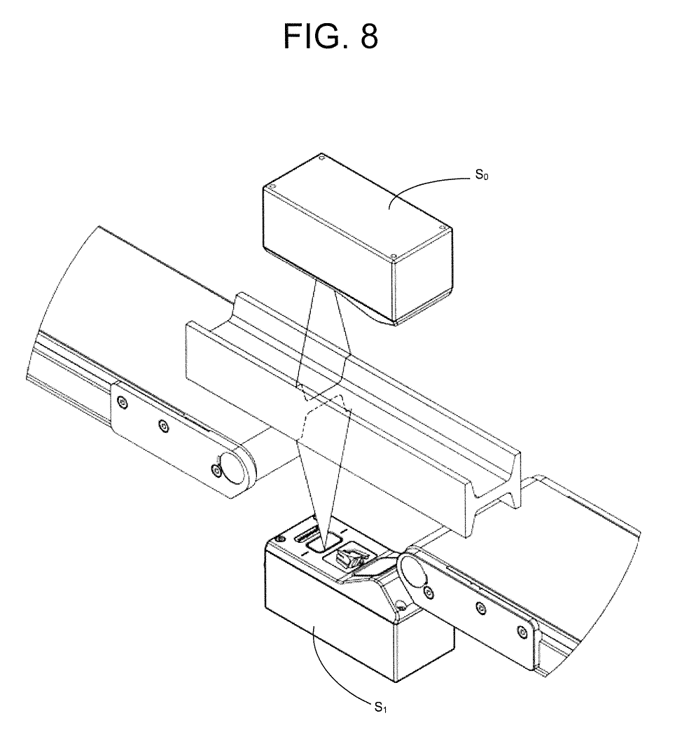

Referring to FIG. 8, in the “opposite” mode the managing sensor S₀ and the support sensor S₁ are placed 180 degrees opposite to one another in the same plane. The profile from the support sensor S₁ is combined with the profile from the managing sensor S₀ to produce a true differential profile.

It will be appreciated by those skilled in the art that the preferred and some alternative embodiments have been described but that certain modifications, variations and enhancements may be practiced without departing from the principles of the invention. For example, the preferred embodiment uses two sensors in the network, although the foregoing description has sometimes referred to other sensors that may be included in the network. Where such is the case, the managing sensors will be called upon to combine multiple images taking into account the relative positions of the various sensors. The managing sensor may also prepare combinations of partial images from subsets of sensors as opposed to combining partial images from all sensors in each case, for example when two production lines are being imaged by a single plurality of sensors having a single designated managing sensor.

As a further example, certain functional modules were described for the preferred embodiment. It will be apparent to those skilled in the art that various other modules or processing approaches may be used.

Further other physical configurations of sensors may be contemplated to accomplish various process control and metrology functions that the examples mentioned herein for illustrative purposes.

We claim:

1. A system for imaging an area using a plurality of non-contact measurement optical sensors, said system comprising:
a plurality of non-contact measurement optical sensors;
said sensors being networked with one another;
each of said sensors being substantially identical;
each of said sensors comprising a computer-readable medium having recorded thereon instructions that when executed cause the sensor to:
detect the presence of a connected network of like sensors;
accept an assignment of either of alternative roles as a managing sensor or a support sensor;
acquire images of respective portions of said area;
when said each sensor is assigned the role of a managing sensor, to combine image data from respective portions of said area that are respectively acquired by each sensor of said plurality of sensors; and
when said each sensor is assigned the role of a support sensor, to deliver to said managing sensor image data from said portion of said area that was acquired by said support sensor.

2. The system of claim 1 wherein said instructions when executed further cause the sensor to:
when said each sensor is assigned the role of a managing sensor, said managing sensor further acts as a sole server for a client for interfacing with said client and for generating and outputting to said client said combined image data.

3. The system of claim 1 wherein said image data combined by said managing sensor comprises images acquired by respective ones of said plurality of sensors, including by said managing sensor, combined to generate a combined image of said area.

4. The system of claim 1 wherein:
said image data combined by said managing sensor comprises representations of portions of an object within said area;
said representations or portions of said objet are derived by respective ones of said plurality of sensors from said images acquired by said respective ones of said plurality of sensors, including by said managing sensor; and,
said representations being combined by said managing sensor to generate a combined representation of said object.

5. The system of claim 1 wherein:
said image data combined by said managing sensor comprises partial dimensional information relating to an object within said area; and,
said dimensional information is derived by respective ones of said plurality of sensors from said images acquired by said respective ones of said plurality of sensors, including by said managing sensor.

6. The system of claim 3, 4 or 5 wherein each of said plurality of sensors is calibrated in relation to a common coordinate reference system.

7. A system for imaging an area using a plurality of non-contact measurement optical sensors, said system comprising:
a first non-contact measurement optical sensor;
a second non-contact measurement optical sensor in networked communication with said first sensor;
each of said first and second sensors being calibrated in relation to a common coordinate reference system;
said first sensor being configured to:
acquire images of a respective portion of said area;
combine image content relating to respective portions of said area that is acquired by each of said first and second sensors and that is normalized to said common coordinate reference system by each of said first and second sensors;
wherein said combining generates combined image content;
act as a server for a client for interfacing with said client and for generating and outputting to said client user content relating to said combined image content;

8. The system of claim 7 wherein said image data combined by said first sensor comprises images acquired by respective ones of said plurality of sensors, including by said first sensor, combined to generate a combined image of said area.

9. The system of claim 7 wherein said image content combined by said first sensor comprises representations of portions of an object within said area, said representations being derived from said images acquired by respective ones of said plurality of sensors, including by said first sensor, said representations being combined to generate a combined representation of said object.

10. The system of claim 1 wherein said instructions when executed further cause each said sensor, when said each sensor is assigned the role of managing sensor to provide system initialization functions.

11. The system of claim 10 wherein said instructions when executed further cause each said sensor, when said each sensor is assigned the role of managing sensor to provide synchronization signals for image acquisition by said plurality of sensors.

12. The system of claim 1 wherein said instructions when executed further cause each said sensor, when said each sensor is assigned the role of managing sensor to provide meteorological functions,

13. A method for imaging an area, said method comprising the steps of:
a first sensor being calibrated with a second sensor to operate in the same effective coordinate system;
said first sensor creating a first age of a first part of said area;
said second sensor creating a second image of a second part of said area;
said second sensor transmitting said second image to said first sensor through a network connection between said first sensor and said second sensor; and
said first sensor combining said first image and said second image to create a combined image of said area.

14. The method of claim 13, further comprising the step of outputting said combined image from said first sensor to a user device networked to said first sensor.

15. The system of claim 1 wherein said instructions when executed further cause each said sensor to:
detect the presence of a connected network of like sensors;
detect a first connection of a client on said network to one of said sensors;
upon detecting said first connection, said one of said sensors delivering to said client a user interface offering to the client an option for a user to operate the network in multi-sensor mode for imaging said area.

16. The system of claim 15 wherein said instructions when executed further cause each said sensor to:
upon detecting said first connection, said one of said sensors delivering to said client a user interface offering to the client an option for a user to assign an IP address to said one of said sensors.

17. The system of claim 16 wherein said instructions when executed further cause each said sensor to:
upon detecting said first connection, said one of said sensors delivering to said client a user interface offering to the client an option for assign to one of said plurality of sensors the role of a managing sensor.

18. The system of claim 17 wherein said instructions when executed further cause each said sensor to:
where said client fails to assign to one of said plurality of sensors the role of a managing sensor, said one of said sensors to which said client first connected on the network assumes the role of managing sensor.

19. The system of claim 16 or 17 wherein said instructions when executed further cause each said sensor, when said each sensor is assigned the role of managing sensor to retain an assignment of a default IP address when said user does not assign an IP address to said managing sensor.

20. The system of claim 15 wherein said instructions when executed further cause each said sensor to:
when said each sensor is assigned the role of managing sensor, prompt said client to specify a relative spatial arrangement of said plurality of sensors.

21. The system of claim 15 wherein said instructions when executed further cause each said sensor to:
when said each sensor is assigned the role of managing sensor, prompt said client to specify operational parameters for said system.

22. A method for imaging an area, said method comprising the steps of:
a first sensor being calibrated with each of one or more other sensors to operate a common effective coordinate system;
said first sensor creating a first image of a first part of said area;
each of said one or more other sensors creating a second image of another part of said area;
each of said one or more other sensors transmitting said second image to said first sensor through a network connection between said first sensor and each of said one or more other sensors; and
said first sensor combining said first image and said second images to create a combined image of said area.

23. The method of claim 22, further comprising the step of outputting said combined image from said first sensor to a user device networked to said first sensor.

24. A method for measuring a distance between a first edge and a second edge of an object, said method comprising the steps of:
a first sensor being placed spaced apart a known distance from a second sensor;
said first sensor creating a first image of said first edge;
said second sensor creating a second image of said second edge;
said second sensor transmitting said second image to said first sensor through a network connection between said first sensor and said second sensor; and
said first sensor calculating said distance based on said first image and said second image.

25. The method of claim 24, where said known distance is determined by calibrating said first sensor and said second sensor to a common effective coordinate system.

26. A method for measuring a change in an object during an interval of time, said method comprising the steps of:
a first sensor being placed spaced apart from a second sensor;
said first sensor creating a first image of said object at a first time instance;
said second sensor creating a second image of said object at a second time instance;
said second sensor transmitting said second image to said first sensor through a network connection between said first sensor and said second sensor; and
said first sensor determining said change in said object by subtracting said first image from said second image.

27. The method of claim 26, wherein said second time instance occurs after said first time instance.

28. The method of claim 26, further comprising the step of said first sensor being calibrated with said second sensor to operate in a common effective coordinate system.

29. A method for producing a differential profile of an object, said method comprising the steps of:
a first sensor being placed spaced apart, substantially 180 degrees opposite and in substantially an identical plane, to a second sensor, wherein said object is placed between said first sensor and said second sensor;
said first sensor creating a first image of said object;
said second sensor creating a second image of said object;
said second sensor transmitting said second image to said first sensor through a network connection between said first sensor and said second sensor; and
said first sensor combining said first image and said second image to create a differential profile of said object.

30. The method of claim 29, further comprising the step of said first sensor being calibrated with said second sensor to operate in a common effective coordinate system.

31. The method of claim 29, further comprising the step of outputting said combined image from said first sensor to a user device networked to said first sensor.

32. A method for imaging an area, said method comprising the steps of:
networking a plurality of sensors with one another, wherein each of said plurality of sensors are substantially identical;
detecting, by each of said plurality of sensors, the presence of a connected network of said sensors;
accepting, by one of said plurality of sensors, an assignment of a role as a managing sensor;
accepting, by remainder of said plurality of sensors, an assignment of a role as a support sensor;
acquiring, by each of said plurality of sensors, an image of a respective portion of said area;
transmitting, by each of said support sensors to said managing sensor, said images of said respective portions of said area; and
combining, by said managing sensor, said images from said support sensors and said image by said managing sensor to create a combined image of said area.

33. The method of claim 32, further comprising the step of outputting, by said managing sensor, said combined image to a client networked with said connected network of said sensors.

34. The system of claim 2, wherein said client is a web browser.

35. The system of claim 34, wherein said web browser is on a computer networked to said managing sensor.

36. The system of claim 2, wherein said client is connected to said connected network through a switch.

37. The system of claim 1, wherein said sensors being networked with one another is through Ethernet connections.

38. The system of claim 1, wherein said sensors are laser line projection sensors.

39. The system of claim 1, wherein said sensors are spot sensors.

40. The system of claim 1, wherein said sensors are time of flight sensors.

41. The system of claim 1, wherein said managing sensor transmits timing signals to each of said support sensors to control acquisition of said images.

42. The system of claim 41, wherein said acquisition of said images synchronous.

43. The system of claim 41, wherein said acquisition of said images is asynchronous.

44. The system of claim 1, wherein said managing sensor commences acquisition of said image based on one of direct user input, external signals, or an imaging schedule.

45. The system of claim 1, wherein said managing sensor provides initialization functions for said connected network.

46. The system of claim 1, wherein said managing sensor provides synchronization functions for said connected network.

47. The system of claim 1, wherein said managing sensor provides meteorological functions.

48. The system of claim 1 further comprising a power source.

49. The system of claim 48, wherein said power source is connected to each of said sensors though a cord set.

50. The system of claim 49, wherein said cord set comprises power cables.

51. The system of claim 1 further comprising one or more cable management devices.

52. The system of claim 51, wherein said cable management devices comprise cable splitters.

53. The system of claim 1, wherein said computer-readable medium further comprises an inter-sensor synchronization module for synchronizing timing among said sensors.

54. The system of claim 1, wherein said computer-readable medium further comprises both a managing sensor engine module and a support sensor module.

55. The system of claim 1, wherein said computer-readable medium further comprises a file system module.

56. The system of claim 55, wherein said file system module is used to store calibration records.

57. The system of claim 55, wherein said file system module is used to store user configurations.

58. The system of claim 55, wherein said file system module comprises a database, wherein said database is used to store metrology algorithms.

59. The system of claim 1, wherein said computer-readable medium further comprises a configuration management module for controlling or more of the following: network awareness, network configuration, selection of user-defined set up, and operational parameters.
